(19) United States
(12) Patent Application Publication
(10) Pub. No.: US 2024/0407351 A1
(43) Pub. Date: Dec. 12, 2024

(54) LASER POWERED INSECT CONTROL DEVICE

(71) Applicant: The FountainHead Group, Inc., New York Mills, NY (US)

(72) Inventor: Andrew C. Putrello, Utica, NY (US)

(73) Assignee: The FountainHead Group, Inc., New York Mills, NY (US)

(21) Appl. No.: 18/640,782

(22) Filed: Apr. 19, 2024

Related U.S. Application Data
(60) Provisional application No. 63/497,610, filed on Apr. 21, 2023.

(51) Int. Cl. A01M 1/20

(52) U.S. Cl. CPC A01M 1/2077

(57) ABSTRACT

An insect control device includes a housing having a front side, a cartridge slot formed through the front side, a power supply compartment, a circuit board compartment, and a cover that is removably positioned in covering relation to the power supply compartment and the circuit board compartment; a diode positioned within the housing and in aligned relation to the cartridge slot; a cartridge containing pesticide that is sized and adapted for placement through the cartridge slot and positioning is spaced relation above the diode; a power supply adapted to be positioned in the power supply compartment; and a circuit board adapted to be positioned in the circuit board compartment and being electrically connected to the power supply and the diode.

### CROSS-REFERENCE TO RELATED APPLICATION

The present application relates and claims priority to U.S. Patent Application 63/497,610, filed Apr. 21, 2023, the entirety of which is hereby incorporated by reference.

### FIELD OF THE INVENTION

The present disclosure is directed to a laser powered insect control device. More particularly, the present invention relates to a tabletop, or portable (user wearable) laser powered insect control device, and, even more particularly, to a low power laser driven insecticide dispenser capable of vaporizing liquid pesticides, igniting solid pesticides, or sublimating pesticide/substrate inserts leaving zero residue behind.

### BACKGROUND

Insect repellent and exterminating devices have been used for many years to provide protection from disease carrying insects during a variety of activities. There are many devices on the market that function in a variety of ways.

Devices of this type can be used during outdoor excursions such as camping, hunting, hiking, and kayaking. Devices such as this can also be used during family picnics, on home decks, at outdoor sporting and car racing events, outdoor festivals, amusement parks, and outdoor concerts.

There are many different types of insect repellent and exterminating devices currently on the market. One such type is a bug zapper. Bug zappers use different wavelengths of light to attract insects to a kill zone where they are electrocuted and dispensed within the device. This type of device attracts insects to the end user's area but not all the bugs make it to the device itself where they can be electrocuted. Many of the bugs find hosts as they enter the area and never make it to the device itself. This type of device can also cause vaporized bug mist to circulate in the surrounding air where the end user inhales it, can be noisy or distracting, and the replacement bulbs are expensive to replace. In addition, what remains of the dead bugs must be disposed of after continued use.

Another type of insect repellent and exterminating device uses butane fuel sources to heat pads treated with a pesticide thus initiating or accelerating the evaporation rate of the pesticide into the surrounding area. Butane is a hydrocarbon and releases carbon dioxide (CO2) into the air when burning efficiently and releases carbon monoxide (CO) into the air when burning inefficiently. This type of device has an area that accepts the pesticide treated pads into a grill with air inlets. If the inlets become blocked or clogged, the butane will not burn efficiently and will release carbon monoxide into the air. The manufacturers of this type of device state that the device should only be used outdoors. It is not known if this is due to the possibility of carbon monoxide production through inefficient combustion or to prevent high concentrations of pesticide within an enclosed area such as a room or tent. This type of device also has spatial orientation limitations as well and must be used on a flat surface—face up. It is also an inconvenience to have to use specialized butane sources to power or refill this type of device. The replaceable butane cartridges are very specialized, expensive, and must be purchase where and when they are available. In addition, you will read on the Internet that there is not an open flame while operating—the key word is open. There is in fact a burning flame inside the devices while operating. The devices are not airtight and must allow oxygen in through vents to enable combustion and that opens the real possibility of a flammable vapor entering the device and leading to an accident under proper conditions—not hyperbole. In addition, they are not TSA approved. The pesticide used in this type of device is d-cis/trans allethrin (21.97%) and requires more energy to be vaporized than some other pesticides available.

Electrically powered insect repellent and exterminating devices also exist and use an electrically heated coil of nichrome wire that surrounds the top of a wick that pulls pesticide up from within a storage container thus accelerating the evaporation of the pesticide into the surrounding area. This type of device also has spatial orientation limitations as well and must be used on a flat surface—face up. the spatial orientation limitation is most likely due to a fairly complex pesticide storage/wick assembly that is very expensive to replace. In addition, the device relies on a chimney effect and convection to release the evaporated pesticide into the surrounding air. Nichrome wire heating elements are used in numerous devices, are primitive, and draw a lot of electrical current.

Accordingly, there is a need in the art for an insect control device that uses laser power to vaporize liquid or gel pesticides.

There is also a need to provide an insect control device that sublimates solid substrate/pesticide crystals into the environment.

There is also a need to provide an insect control device that ignites, or smothers, a solid pesticide pellets and release pesticide into the environment.

There is also a need to provide an insect control device that uses waste heat to assist in vaporizing pesticides.

There is also a need to provide an insect control device that uses cool air inlets to facilitate the release of heated vaporized pesticides.

There is also a need to provide an insect control device that runs on low power.

There is also a need to provide an insect control device that does not have spatial orientation limitations.

There is also a need to provide an insect control device that does not require cleaning.

### SUMMARY

The present disclosure is directed to a laser powered insect control device.

According to an aspect is an insect control device, comprising a housing having a front side, a cartridge slot formed through the front side, a power supply compartment, a circuit board compartment, and a cover that is removably positioned in covering relation to the power supply compartment and the circuit board compartment; a diode positioned within the housing and in aligned relation to the cartridge slot; a cartridge containing pesticide that is sized and adapted for placement through the cartridge slot and positioning is spaced relation above the diode; a power supply adapted to be positioned in the power supply compartment; and a circuit board adapted to be positioned in the circuit board compartment and being electrically connected to the power supply and the diode.

According to an embodiment, the insect control device further comprises an exhaust vent formed in the cover and in aligned relation to the cartridge.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1A and FIG. 1B are top plan views of the cover and housing of an insect control device, respectively, in accordance with an embodiment.

FIG. 2 is a cross-sectional view taken along line 2-2 of FIG. 1B, in accordance with an embodiment.

FIG. 3 is an exploded perspective elevation view of an insect control device, in accordance with an embodiment.

### DETAILED DESCRIPTION OF EMBODIMENTS

The present disclosure describes a laser powered insect control device.

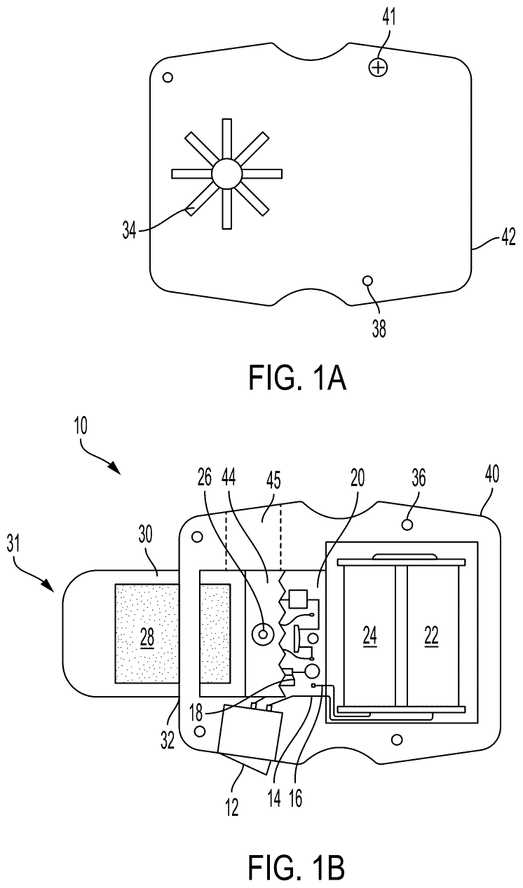

Referring to FIGS. 1A and 1B, in one embodiment, is each element of the laser powered insect control device 10 is briefly described. A full description of the function and operation of the laser powered insect control device 10 will follow. The laser powered insect control device 10 of the inventions includes a power switch 12, positive battery lead 14, negative battery lead 16, circuit board switch lead 18, circuit board 20 and laser diode 26. The laser diode 26 has a wavelength of 405 nm to 488 nm but any suitable wavelength can be used. The laser powered insect control device 10 also includes two rechargeable Li-ion batteries, battery number one 22 and battery number two 24. The laser powered insect control device 10 also includes a pesticide substrate 28 and substrate frame 30 that together form a pesticide insert 31. All components of the laser powered insect control device 10 are enclosed within a housing 40 that includes an air intake 45 and housing cover 42 that includes exhaust vents 34. The housing 40 and housing cover 42 can be fabricated from plastic or other suitable material and can be of any shape or size. The housing cover 42 is designed to block any laser light from leaving the inside of the housing 40. The pesticide insert 31 is inserted into the laser powered insect control device 10 through the pesticide insert slot 32 located within the housing 40. Screw fasteners 41 are used to secure the housing cover 42 to the housing 40 through the housing mounting holes 36 and cover mounting holes 38. The laser powered insect control device 10 also includes a laser diode heat sink 44, that in conjunction with the circuit board 20, maintain the proper operating temperature of the laser diode 26 and prevent the laser diode 26 from overheating during operation.

In operation and referring to FIG.1, the user first inserts the pesticide insert 31 into the housing 40 by sliding it into the pesticide insert slot 32. This positions the pesticide infused substrate directly over the laser diode 26 and laser diode heat sink 44. The top of the laser diode heat sink 44 has the same shape and size as the pesticide substrate 28. Next the user presses the power switch 12 to initiate electron flow. The electrons travel from battery number one 22 and battery number two 24 through the positive battery lead 14, negative battery lead 16, and circuit board switch lead 18 to supply electrons to the circuit board 20 that controls and illuminates the laser diode 26. The circuit board 20 provides accurate voltage and current regulation of the laser diode 26 and also controls the duty cycle by controlling the flash-rate and on-off durations of the laser diode 26. As a result, the vaporization rate of the pesticide can be precisely controlled by the circuit board 20 using the minimum energy necessary to achieve the desired vaporization rates. Once the laser diode 26 is illuminated, it shines on the substrate infused with pesticide and vaporizes the pesticide into the surrounding environment at the desired vaporization rate. To minimize wasted energy in the system, the laser diode heat sink 44 is positioned in proximity to the pesticide infused substrate and uses the waste heat produced during the operation of the laser diode 26 to assist in the vaporization of the pesticide that is infused into the substrate. In addition to being able to vaporize pesticides that have been infused into a substrate, the laser diode 26 can also sublimate solid crystals doped with pesticide directly into the surrounding environment leaving no byproducts or residue behind. One such method (would also like to claim this) is to grow menthol crystals doped with a pesticide such as metofluthrin. Menthol and metofluthrin both repel (metofluthrin also kills) insects and menthol/metofluthrin crystals can be sublimated directly into the surrounding environment by the laser diode 26 when inserted into the laser powered insect control device 10. The laser powered insect control device 10 can also ignite or smother pellets of pesticide making the device more versatile than prior art. Vaporization of liquids can also be achieved by shining the laser on to a suitable substrate designed to absorb the laser energy and then dripping liquid pesticide onto he heated substrate. Once vaporization or sublimation has taken place in the laser powered insect control device 10 the pesticide is released into the surrounding environment through the exhaust vents 34 built into the housing cover 42. Warm rising pesticide vapor escaping through the exhaust vents 34 is replace by cooler air through an air intake 45 located on the side of the housing 40 thus facilitating the release of pesticide into the surrounding environment.

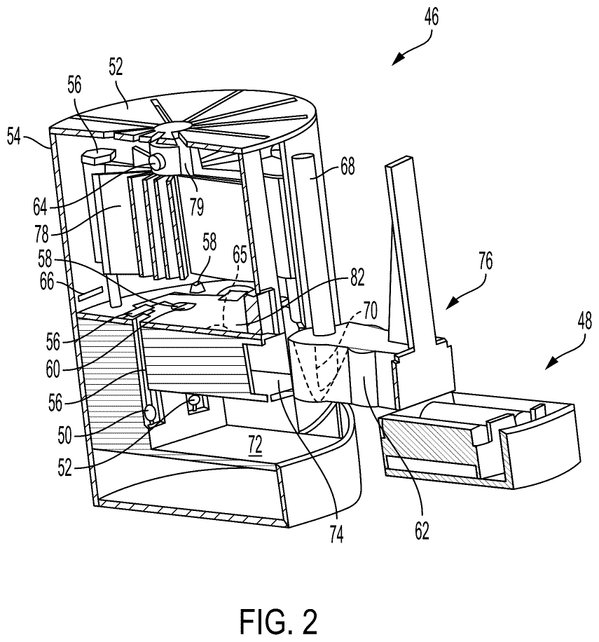

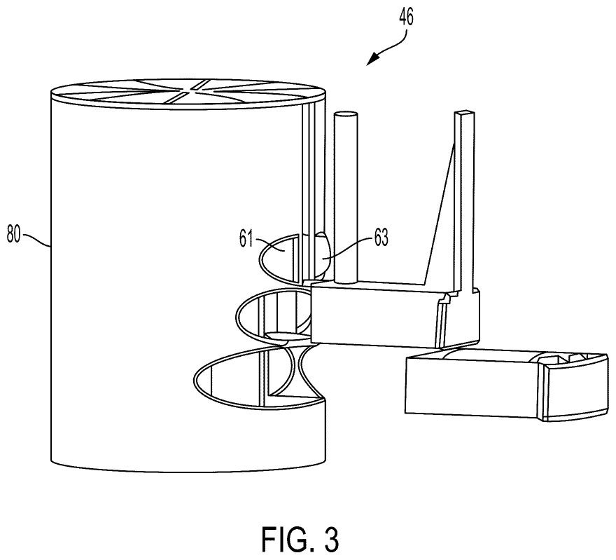

FIG. 2 is a section view and FIG. 3 is an exploded view of an alternate embodiment of a laser powered insect control device 46 as compared to the laser powered insect control device 10. Each element of the alternate device 46 is briefly described. A full description of the function and operation of the alternate device 46 will follow.

Referring to FIG. 2 and FIG. 3, The alternate device 46 includes a, battery cartridge 48, magnetic circuit board contact one 50, magnetic circuit board contact two 52, circuit board bridge contact one 54, circuit board contact one 56, circuit board contact two 58, circuit board bridge contact two 60, lighted switch 61, locking nub 62, battery level indicator 63, side mount laser diode 64, cool air intake slots 66, evaporation wick 68, pesticide reservoir 70, battery cartridge compartment 72, pesticide cartridge compartment 74, pesticide cartridge 76, cylindrical heat sink 78, and alternate housing 80, and round circuit board 82.

In operation and referring to FIG. 2 and FIG. 3, the user inserts the battery cartridge 48 into the battery cartridge compartment 72. Once inserted, the battery cartridge 48 magnetically and electrically locks into place when it makes contact with magnetic circuit board contact one 50 and magnetic circuit board contact two 52 that are electrically connected through circuit board bridge contact one 54 and circuit board bridge contact two 60 that protrude and fold over below the circuit board 20 to allow contact with circuit board contact one 56 and circuit board contact two 58 completing the electrical circuit from the battery cartridge 48 to the circuit board 20. Next the user inserts the pesticide cartridge 76 into the pesticide cartridge compartment 74. The pesticide cartridge 76 locks into place as contact is made between the locking nub 62 and an opposing locking nub recess 65 within the pesticide cartridge compartment 74. The user then presses the lighted switch 61 to illuminate the side mount laser diode 64. The battery level indicator 63 will automatically display battery life remaining. The laser diode 26 shines on the evaporation wick 68 vaporizing the pesticide into the surrounding air. To minimize wasted energy in the system, the cylindrical heat sink 78 receives the evaporation wick 68 through evaporation wick slot 79 allowing the evaporation wick 68 to be located within the cylindrical heat sink 78 without the need to open the alternate housing 80. This allows the use of what would otherwise be wasted heat produced during the operation of the side mount laser diode 64 26, to assist in the vaporization of the pesticide off the evaporation wick 68. As explained in the preferred embodiment, the evaporation wick 68 may be replace with a crystal substrate/pesticide solid to be sublimated, or a solid pesticide rod that could be sublimated, ignited, or smothered. The evaporation wick 68 may also be replace by a capillary tube. Once vaporization begins the pesticide is released through the exhaust vents 34 and cool air replaces the evacuated warm vaporized pesticide through the cool air intake slots 66 thus facilitating the release. The cylindrical heat sink 78 may also be incorporated into the pesticide reservoir 70 to preheat the pesticide and facilitate vaporization.

Since other modifications and changes varied to fit operating requirements and environments will be apparent to those skilled in the art, the invention is not considered limited to the example chosen for purposes of disclosure and covers all changes and modifications which do not constitute departures from the true spirit and scope of this invention.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software, or a combination thereof. When any aspect of an embodiment is implemented at least in part in software, the software code can be executed on any suitable processor or collection of processors, whether provided in a single device or computer or distributed among multiple devices/computers.

What is claimed is:

1. An insect control device, comprising:
a. a housing having a front side, a cartridge slot formed through the front side, a power supply compartment, a circuit board compartment, and a cover that is removably positioned in covering relation to the power supply compartment and the circuit board compartment;
b. a diode positioned within the housing and in aligned relation to the cartridge slot;
c. a cartridge containing pesticide that is sized and adapted for placement through the cartridge slot and positioning is spaced relation above the diode;
d. a power supply adapted to be positioned in the power supply compartment; and
e. a circuit board adapted to be positioned in the circuit board compartment and being electrically connected to the power supply and the diode.

2. The insect control device according to claim 1, further comprising an exhaust vent formed in the cover and in aligned relation to the cartridge.
